(19) United States
(12) Patent Application Publication
(10) Pub. No.: US 2019/0126463 A1
(43) Pub. Date: May 2, 2019

(54) ROBOTIC ASSISTED ACTION TEMPLATE GENERATION BASED ON PROFILE

(71) Applicant: BANK OF AMERICA CORPORATION, Charlotte, NC (US)

(72) Inventor: Sasidhar Purushothaman, Hyderabad, IN (US)

(21) Appl. No.: 15/798,709

(22) Filed: Oct. 31, 2017

(51) Int. Cl. B25J 9/00; G06Q 40/02

(52) U.S. Cl. CPC B25J 9/0084; G06Q 40/02

(57) ABSTRACT

Systems, computer program products, and methods are described herein for automated deployment of pre-configured bots for executing one or more actions initiated by a user within a technology environment based on a supervised classification of the user into a predetermined class. The present invention is configured to receive information associated with one or more actions initiated by a user within a technology environment; generate one or more primary data points; classify the user into a class based on at least the one or more primary data points generated; retrieve one or more pre-configured bots associated with the class; and deploy the one or more pre-configured bots to execute the one or more actions initiated by the user.

### FIELD OF THE INVENTION

The present invention embraces a system, a method and a product in the context of robotic process automation (RPA).

### BACKGROUND

Entities are beginning to integrate robotic process automation (RPA) together with cognitive technologies such as speech recognition, natural language processing, and machine learning to automate perpetual and judgement-based tasks. This integration of cognitive technologies and RPA is extending automation to new areas and can help companies become more efficient and agile as they move down the path of becoming fully digital.

There is a need for a system to dynamically learn and adapt to changes in sequence of workflow and interactions to address real-time user requests and progressive needs.

### SUMMARY

The following presents a simplified summary of one or more embodiments of the present invention, in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

In one aspect, a system for automated deployment of pre-configured bots for executing one or more actions initiated by a user within a technology environment based on a supervised classification of the user into a predetermined class, the system comprising: at least one non-transitory memory device with computer-readable code stored thereon; at least one processing device; and at least one module stored in said memory device and comprising instruction code that is executable by the at least one processing device and configured to cause said at least one processing device to: receive information associated with one or more actions initiated by a user within a technology environment; generate one or more primary data points based on at least receiving information associated with one or more actions; classify the user into a class based on at least the one or more primary data points generated; retrieve one or more pre-configured bots associated with the class, wherein the class is associated with one or more predetermined primary data points, wherein the one or more pre-configured bots are capable of executing the one or more actions initiated by the user; and deploy the one or more pre-configured bots to execute the one or more actions initiated by the user.

In some embodiments, the module is further configured to classify the user into the class, wherein classifying further comprises comparing the generated one or more primary data points with the one or more predetermined primary data points associated with the class.

In some embodiments, the class is associated with one or more groups of one or more pre-configured bots.

In some embodiments, the module is further configured to retrieve the one or more pre-configured bots, wherein retrieving further comprises retrieving the one or more pre-configured bots associated with at least one of the one or more groups.

In some embodiments, the module is further configured to continuously update the class associated with the user based on at least receiving information associated with one or more actions initiated by the user in real-time within the technology environment.

In some embodiments, continuously updating further comprises: monitoring the one or more actions executed by the one or more pre-configured bots deployed to execute the one or more actions initiated by the user; receiving an indication that the one or more actions have been executed by the one or more pre-configured bots; initiating a presentation of user interface for display on a user device, the user interface comprising one or more selectable options for the user to indicate whether the one or more actions initiated by the user have been executed successfully by the one or more pre-configured bots; and receiving, via the user interface, a user selection of at least one of the one or more options indicating that the one or more pre-configured bots have successfully executed the one or more actions initiated by the user.

In some embodiments, the module is further configured to: receive, via the user interface, the user selection of at least one of the one or more options indicating that the one or more pre-configured bots have not successfully executed the one or more actions initiated by the user; receive, from the user, information associated with one or more actions initiated by the user that were not executed by the one or more pre-configured bots; re-configure the one or more pre-configured bots to execute the one or more actions initiated by the user that were not executed by the one or more pre-configured bots; and re-deploy the one or more pre-configured bots.

In another aspect, a computerized method for automated deployment of pre-configured bots for executing one or more actions initiated by a user within a technology environment based on a supervised classification of the user into a predetermined class, the method comprising: receiving information associated with one or more actions initiated by a user within a technology environment; generating one or more primary data points based on at least receiving information associated with one or more actions; classifying the user into a class based on at least the one or more primary data points generated; retrieving one or more pre-configured bots associated with the class, wherein the class is associated with one or more predetermined primary data points, wherein the one or more pre-configured bots are capable of executing the one or more actions initiated by the user; and deploying the one or more pre-configured bots to execute the one or more actions initiated by the user.

In yet another aspect, a computer program product for automated deployment of pre-configured bots for executing one or more actions initiated by a user within a technology environment based on a supervised classification of the user into a predetermined class, the computer program product comprising a non-transitory computer-readable medium comprising code causing a first apparatus to: receive information associated with one or more actions initiated by a user within a technology environment; generate one or more primary data points based on at least receiving information associated with one or more actions; classify the user into a class based on at least the one or more primary data points generated; retrieve one or more pre-configured bots associated with the class, wherein the class is associated with one or more predetermined primary data points, wherein the one or more pre-configured bots are capable of executing the one or more actions initiated by the user; and deploy the one or more pre-configured bots to execute the one or more actions initiated by the user.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 presents an exemplary block diagram of the system environment for automated deployment of pre-configured bots for executing one or more actions initiated by a user within a technology environment based on a supervised classification of the user into a predetermined class, in accordance with an embodiment of the invention;

FIG. 2 illustrates a high level process flow for automated deployment of pre-configured bots for executing one or more actions initiated by a user within a technology environment based on a supervised classification of the user into a predetermined class, in accordance with an embodiment of the invention;

FIG. 3 illustrates a process flow for monitoring deployment within the technology environment, in accordance with an embodiment of the invention; and

FIG. 4 illustrates a process flow for re-deploying the pre-configured bots to execute the actions initiated by the user, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In some embodiments, an “entity” as used herein may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. In some embodiments, a “user” may be an employee (e.g., a developer, a coder, an architect, an associate, a project manager, an IT specialist, a manager, an administrator, an internal operations analyst, or the like) of the entity or enterprises affiliated with the entity, capable of operating the systems described herein. In some embodiments, a “user” may be any individual, entity or system who has a relationship with the entity, such as a customer.

A “user interface” is any device or software that allows a user to input information, such as commands or data, into a device, or that allows the device to output information to the user. For example, the user interface include a graphical user interface (GUI) or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users.

As used herein, a “bot” is a configurable software set up to perform specific tasks assigned and controlled by a user. A bot is capable of interacting with one or more computing devices and/or third party applications to execute specific functionalities of each system and/or application based on its assigned task. Further, bots are capable of interpreting the user interface of the third party applications and are configured to execute steps identically to a human user. In addition, bots may be configured (or “trained”) using demonstrative steps, rather than being programmed using code-based instructions.

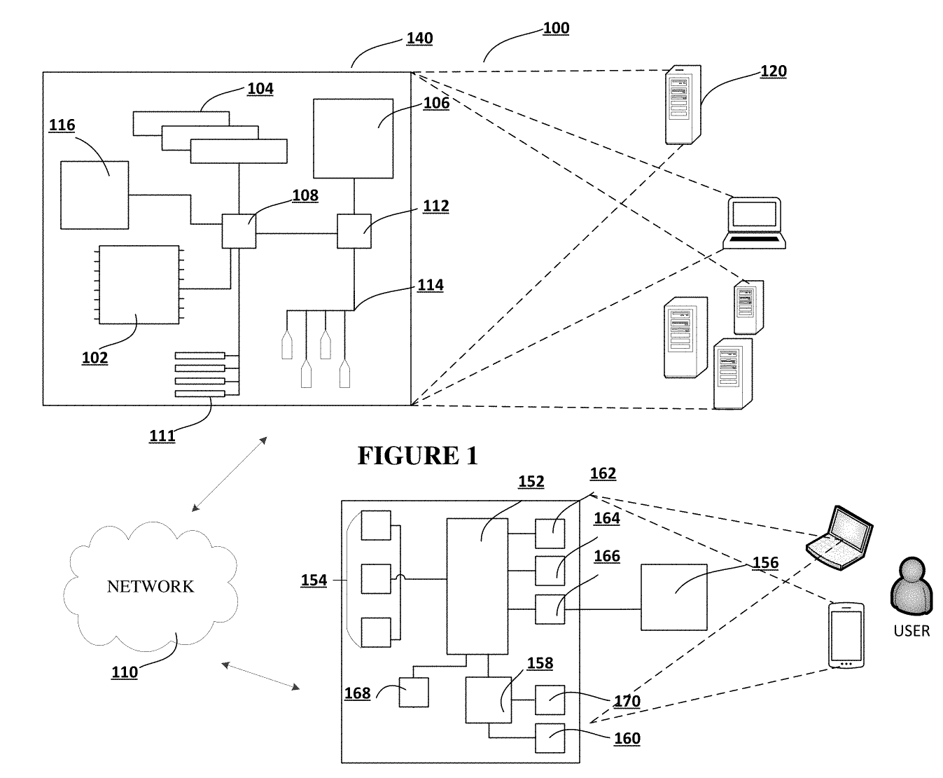

FIG. 1 presents an exemplary block diagram of the system environment for automated deployment of pre-configured bots for executing one or more actions initiated by a user within a technology environment based on a supervised classification of the user into a predetermined class 100, in accordance with an embodiment of the invention. FIG. 1 provides a unique system that includes specialized servers and system communicably linked across a distributive network of nodes required to perform the functions of the process flows described herein in accordance with embodiments of the present invention.

As illustrated, the system environment 100 includes a network 110, a system 130, and a user input system 140. Also shown in FIG. 1 is a user of the user input system 140. The user input system 140 may be a mobile device or other non-mobile computing device. The user may be a person who uses the user input system 140 to execute one or more applications stored thereon. The one or more applications may be configured to communicate with the system 130, perform a transaction, input information onto a user interface presented on the user input system 140, or the like. The applications stored on the user input system 140 and the system 130 may incorporate one or more parts of any process flow described herein.

As shown in FIG. 1, the system 130, and the user input system 140 are each operatively and selectively connected to the network 110, which may include one or more separate networks. In addition, the network 110 may include a telecommunication network, local area network (LAN), a wide area network (WAN), and/or a global area network (GAN), such as the Internet. It will also be understood that the network 110 may be secure and/or unsecure and may also include wireless and/or wired and/or optical interconnection technology.

In some embodiments, the system 130 and the user input system 140 may be used to implement the processes described herein, including the mobile-side and server-side processes for installing a computer program from a mobile device to a computer, in accordance with an embodiment of the present invention. The system 130 is intended to represent various forms of digital computers, such as laptops, desktops, workstations, personal digital assistants, servers, blade servers, mainframes, and other appropriate computers. The user input system 140 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

In accordance with some embodiments, the system 130 may include a processor 102, memory 104, a storage device 106, a high-speed interface 108 connecting to memory 104, and a low-speed interface 112 connecting to low speed bus 114 and storage device 106. Each of the components 102, 104, 106, 108, 111, and 112 are interconnected using various buses, and may be mounted on a common motherboard or in other manners as appropriate. The processor 102 can process instructions for execution within the system 130, including instructions stored in the memory 104 or on the storage device 106 to display graphical information for a GUI on an external input/output device, such as display 116 coupled to a high-speed interface 108. In other implementations, multiple processors and/or multiple buses may be used, as appropriate, along with multiple memories and types of memory. Also, multiple systems, same or similar to system 130 may be connected, with each system providing portions of the necessary operations (e.g., as a server bank, a group of blade servers, or a multi-processor system). In some embodiments, the system 130 may be a server managed by the business. The system 130 may be located at the facility associated with the business or remotely from the facility associated with the business.

The memory 104 stores information within the system 130. In one implementation, the memory 104 is a volatile memory unit or units, such as volatile random access memory (RAM) having a cache area for the temporary storage of information. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 1408 manages bandwidth-intensive operations for the system 130, while the low speed controller 112 manages lower bandwidth-intensive operations. Such allocation of functions is exemplary only. In some embodiments, the high-speed interface 108 is coupled to memory 104, display 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms, as shown in FIG. 1. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 140 may be made up of multiple computing devices communicating with each other.

FIG. 1 also illustrates a user input system 140, in accordance with an embodiment of the invention. The user input system 140 includes a processor 152, memory 154, an input/output device such as a display 156, a communication interface 158, and a transceiver 160, among other components. The user input system 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the user input system 140, including instructions stored in the memory 154. The processor may be implemented as a chipset of chips that include separate and multiple analog and digital processors. The processor may be configured to provide, for example, for coordination of the other components of the user input system 140, such as control of user interfaces, applications run by user input system 140, and wireless communication by user input system 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of user input system 140 with other devices. External interface 168 may provide, for example, for wired communication in some implementations, or for wireless communication in other implementations, and multiple interfaces may also be used.

The memory 154 stores information within the user input system 140. The memory 154 can be implemented as one or more of a computer-readable medium or media, a volatile memory unit or units, or a non-volatile memory unit or units. Expansion memory may also be provided and connected to user input system 140 through an expansion interface (not shown), which may include, for example, a SIMM (Single In Line Memory Module) card interface. Such expansion memory may provide extra storage space for user input system 140, or may also store applications or other information therein. In some embodiments, expansion memory may include instructions to carry out or supplement the processes described above, and may include secure information also. For example, expansion memory may be provided as a security module for user input system 140, and may be programmed with instructions that permit secure use of user input system 140. In addition, secure applications may be provided via the SIMM cards, along with additional information, such as placing identifying information on the SIMM card in a non-hackable manner. In some embodiments, the user may use the applications to execute processes described with respect to the process flows described herein. Specifically, the application executes the process flows described herein. It will be understood that the one or more applications stored in the system 130 and/or the user computing system 140 may interact with one another and may be configured to implement any one or more portions of the various user interfaces and/or process flow described herein.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the user input system 140 to transmit and/or receive information or commands to and from the system 130. In this regard, the system 130 may be configured to establish a communication link with the user input system 140, whereby the communication link establishes a data channel (wired or wireless) to facilitate the transfer of data between the user input system 140 and the system 130. In doing so, the system 130 may be configured to access one or more aspects of the user input system 140, such as, a GPS device, an image capturing component (e.g., camera), a microphone, a speaker, or the like.

The user input system 140 may communicate with the system 130 (and one or more other devices) wirelessly through communication interface 158, which may include digital signal processing circuitry where necessary. Communication interface 158 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 160. In addition, short-range communication may occur, such as using a Bluetooth, Wi-Fi, or other such transceiver (not shown). In addition, GPS (Global Positioning System) receiver module 170 may provide additional navigation- and location-related wireless data to user input system 140, which may be used as appropriate by applications running thereon, and in some embodiments, one or more applications operating on the system 130.

The user input system 140 may also communicate audibly using audio codec 162, which may receive spoken information from a user and convert it to usable digital information. Audio codec 162 may likewise generate audible sound for a user, such as through a speaker, e.g., in a handset of user input system 140. Such sound may include sound from voice telephone calls, may include recorded sound (e.g., voice messages, music files, etc.) and may also include sound generated by one or more applications operating on the user input system 140, and in some embodiments, one or more applications operating on the system 130.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

It will be understood that the embodiment of the system environment illustrated in FIG. 1 is exemplary and that other embodiments may vary. As another example, in some embodiments, the system 130 includes more, less, or different components. As another example, in some embodiments, some or all of the portions of the system environment 100 may be combined into a single portion. Likewise, in some embodiments, some or all of the portions of the system 130 may be separated into two or more distinct portions.

In Robotic Process Automation (RPA), a computer system or robot may mimic the actions of a human being in order to perform a computer-based task. In other words, RPA can be used to interact with application software (or application, for short) through its user interface (presentation layer), as a human being would do. Therefore it is not necessary to integrate RPA with the existing applications at a programming level, thereby eliminating the difficulties inherent to integration, namely bringing together diverse components. In this way, RPA can be used to automate the execution of repetitive and manually intensive activities. RPA's potential benefits are manifold. They can include reducing costs (by cutting staff), lowering error rates, improving service, reducing turnaround time, increasing the scalability of operations, and improving compliance.

In some embodiments, the bots used to execute the applications may be stored locally on the computing device the user is interacting with. In some other embodiments, the bots used to execute the applications may be stored on a cloud provider's servers rather than on the computing device the user is interacting with. In this regard, the system may be configured to host a virtual desktop that connects to applications and data that are stored on a cloud provider's servers rather than on the user's computer or an entity's network. Each virtual desktop instance exists as a virtual machine on the service provider's servers. To the end users, the experience is typically indistinguishable from one in which all their data and applications are local. A virtual desktop provides a significant advantage to the entity in terms of accessibility, cost savings with respect to hardware and their corresponding operating expenses, flexibility and agility for their technology environment, and the ability to support multiple devices concurrently.

The present invention provides the functional benefit of identifying bots capable of dynamically learning and adapting to changes in sequence of workflow and interactions, and execute applications to address real-time user requests and progressive needs.

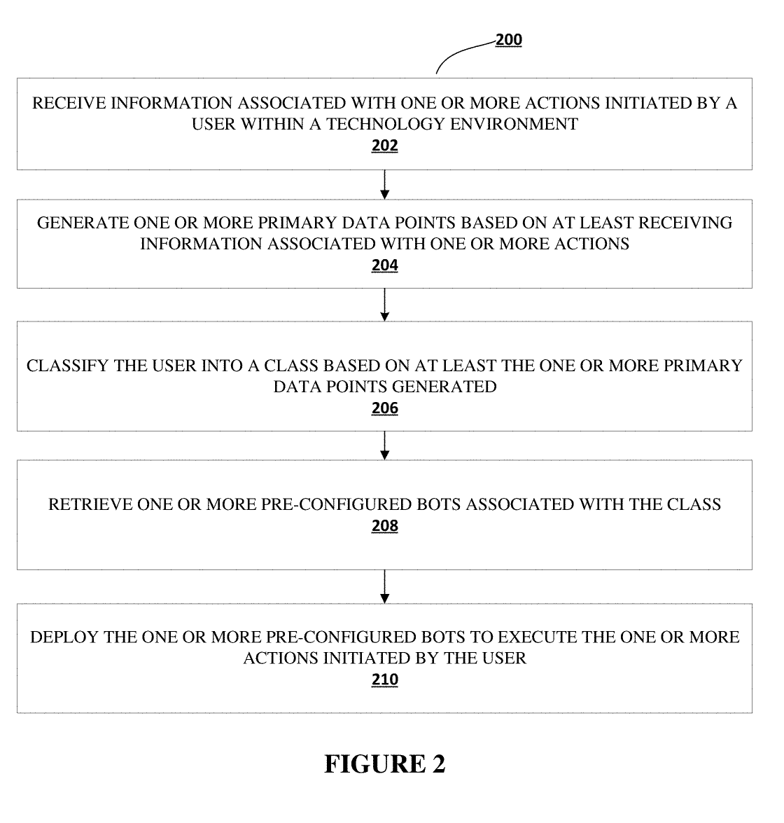

FIG. 2 illustrates a high level process flow for automated deployment of pre-configured bots for executing one or more actions initiated by a user within a technology environment based on a supervised classification of the user into a predetermined class 200, in accordance with an embodiment of the invention. As shown in block 202, the process flow includes receiving information associated with one or more actions initiated by a user within a technology environment. In one aspect, the system may be configured to receive information associated with any interaction of the user with one or more third party applications within the technology environment. In some embodiments, the user interaction includes, but is not limited to, initiation of a third party application on a technology platform, navigation of a user interface associated with the third party application, executing one or more actions via the third party application, thereby affecting a physical transformation within the technology environment, or the like. For example, in a transaction that involves data being temporarily stored in a volatile memory for preliminary processing, a user interaction may include initiating a third party application to retrieve data from the volatile memory. In another example, in a similar transaction, a user interaction may include clearing the volatile memory once the preliminary processing on the stored data is completed.

Next, as shown in block 204, the process flow includes generating one or more primary data points based on at least receiving information associated with the one or more actions. In some embodiments, the system may be configured to record each of the one or more actions initiated by the user. For example, users may approach a physical location associated with the financial institution to execute a transaction. This may typically involve users interacting with an employee located in the physical location such as a bank teller. Such interactions involve the users initiating a transaction request with the employee. In response, the employee typically executes a specific set of actions based on the nature of the transaction initiated by the users. In executing the transaction executed by each user, the employee may access and/or navigate one or more applications within the technology environment in a unique manner. In generating the primary data points, the system may be configured to record these initial set of measured data (actions of the employee) and build derived values (primary data points) intended to be informative and non-redundant, and in some cases leading to better human interpretations. In some embodiments, actions of the user are analyzed into a set of quantifiable properties. These properties may include, but are not limited to, categorical, ordinal, integer-valued, real-valued, based on comparing observations to previous observations, or any combination of the above. In this example, the primary data points may be reduced the absolute minimum number of actions required to execute a transaction initiated by each user.

Next, as shown in block 206, the process flow includes classifying the user into one or more classes based on at least the one or more primary data points generated. In this regard, the system may be configured to implement a classifier (a mathematical function), implemented by a classification algorithm that maps the user into a particular class. In some embodiments, the system may be configured to classify the user into one or more classes by comparing the primary data points generated based on the actions initiated by the user with predetermined primary data points associated with the class. In this regard, the system may be configured to continuously monitor user actions associated with one or more peers of the user and generate primary data points accordingly. In doing so, the system may be configured to match the actions executed by each peer and associate the action with the primary data points, thereby creating a class for that particular action executed by each peer. In this way, each time a user initiates the particular action, the system may be configured to determine the corresponding class by comparing the primary data points generated in response to the actions initiated by the user and the predetermined primary data points associated with the class. In response to the match, the system may be configured to classify the user into at least one of one or more classes accordingly. In some embodiments, the user may be classified into multiple classes based on the actions initiated by the user.

Next, as shown in block 208, the process flow includes retrieving one or more pre-configured bots associated with the class. In some embodiments, the one or more pre-configured bots are capable of executing the one or more actions initiated by the user. As used herein, a “bot” refers to a virtual software component capable of being designed in any programming language, operate on a server or on a client, or be a mobile agent, etc. Typically, bots are capable of performing repetitive rule-based tasks involving structured data on user interfaces of third party applications. Further, bots are capable of replicating the actions of a human beings interacting with the user interface associated with one or more third party applications within a technology environment. In some embodiments, the system may be configured to incorporate cognitive technologies, including speech recognition, natural language processing, and machine learning to automate perceptual and judgment-based tasks once reserved for humans. The integration of cognitive technologies with RPA makes it possible to extend automation to processes that require perception or judgment. With the addition of natural language processing, chat-bot technology, speech recognition, and computer vision technology, for instance, the system may be configured to program the bots to extract and structure information from speech audio, text, or images.

In some embodiments, the pre-configured bots associated with a class may be organized into one or more groups based on at least one or more executable actions. In retrieving pre-configured bots associated with the class, the system may be configured to retrieve bots from multiple groups to execute the action initiated by the user. While most actions are executable by a particular group of bots pre-configured to execute those actions, some actions may require the system to select bots in an ad-hoc method based on the initiated action from multiple groups of pre-configured bots.

Next, as shown in block 210, the process flow includes deploying the one or more pre-configured bots to execute the one or more actions initiated by the user.

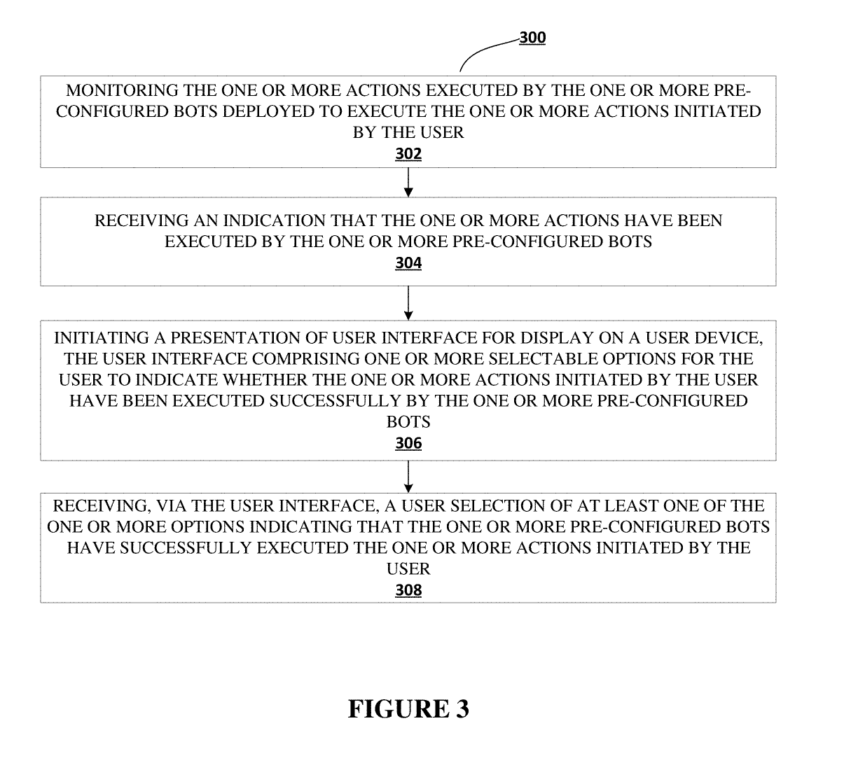

FIG. 3 illustrates a process flow for monitoring deployment within the technology environment 300, in accordance with an embodiment of the invention. As shown in block 302, the process flow includes monitoring the one or more actions executed by the one or more pre-configured bots deployed to execute the one or more actions initiated by the user. In response, the system may be configured to receive an indication that the one or more actions have been executed by the one or more pre-configured bots, as shown in block 304.

In response to receiving the indication, the process flow includes initiating a presentation of a user interface for display on a user device, the user interface comprising one or more selectable options for the user to indicate whether the one or more actions initiated by the user have been executed successfully by the one or more pre-configured bots, as shown in block 306. In some embodiments, the one or more selectable options may include an option in the affirmative and an option in the negative for the user to select, indicating whether the one or more actions initiated by the user have been executed successfully by the one or more pre-configured bots. In some other embodiments, the one or more selectable options may include the various actions executed by the pre-configured bots. This enables the user to compare the actions the user intended to execute with the list of actions executed by the pre-configured bots, thereby determining whether the pre-configured bots have executed the one or more actions initiated by the user.

Next, as shown in block 308, the process flow includes receiving, via the user interface, a user selection of at least one of the one or more options indicating that the one or more pre-configured bots have successfully executed the one or more actions initiated by the user.

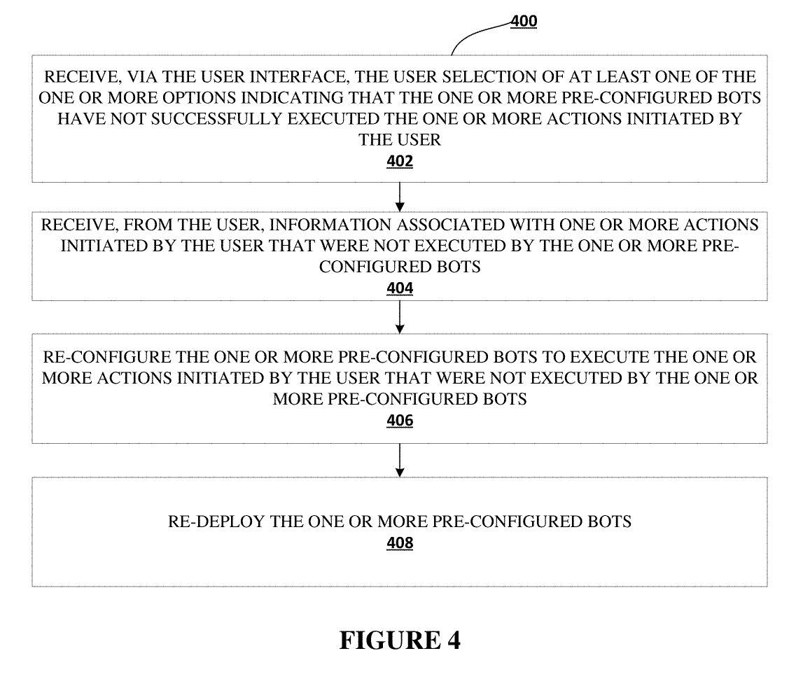

FIG. 4 illustrates a process flow for re-deploying the pre-configured bots to execute the actions initiated by the user 400, in accordance with an embodiment of the invention. As shown in block 402, the process flow includes receiving via the user interface, the user selection of the one or more options indicating that the one or more pre-configured bots have not successfully executed the one or more actions initiated by the user. Next, the process flow includes receiving, from the user, information associated with one or more actions initiated by the user that were not executed by the one or more pre-configured bots, as shown in block 404. In some embodiments, the system may be configured to receive a user selection indicating in the negative that the pre-configured bots have not executed the actions initiated by the user. In some other embodiments, the system may be configured to receive a user selection of one or more specific actions indicating the actions that the pre-configured bots have not successfully executed. This may include incomplete execution of the action, or an action that was never executed.

In response, the process flow includes re-configuring the one or more pre-configured bots to execute the one or more actions initiated by the user that were not executed by the one or more pre-configured bots, as shown in block 406. In some embodiments, the system may be configured to re-train the pre-configured bots to incorporate the actions previously not executed by the pre-configured bots. Once the pre-configured bots are retrained, the process flow then includes re-deploying the one or more pre-configured bots, as shown in block 408.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for automated deployment of pre-configured bots for executing one or more actions initiated by a user within a technology environment based on a supervised classification of the user into a predetermined class, the system comprising:
at least one non-transitory memory device with computer-readable code stored thereon;
at least one processing device; and
at least one module stored in said memory device and comprising instruction code that is executable by the at least one processing device and configured to cause said at least one processing device to:
receive information associated with one or more actions initiated by a user within a technology environment;
generate one or more primary data points based on at least receiving information associated with one or more actions;
classify the user into a class based on at least the one or more primary data points generated;
retrieve one or more pre-configured bots associated with the class, wherein the class is associated with one or more predetermined primary data points, wherein the one or more pre-configured bots are capable of executing the one or more actions initiated by the user; and
deploy the one or more pre-configured bots to execute the one or more actions initiated by the user.

2. The system of claim 1, wherein the module is further configured to classify the user into the class, wherein classifying further comprises comparing the generated one or more primary data points with the one or more predetermined primary data points associated with the class.

3. The system of claim 1, wherein the class is associated with one or more groups of one or more pre-configured bots.

4. The system of claim 3, wherein the module is further configured to retrieve the one or more pre-configured bots, wherein retrieving further comprises retrieving the one or more pre-configured bots associated with at least one of the one or more groups.

5. The system of claim 1, wherein the module is further configured to continuously update the class associated with the user based on at least receiving information associated with one or more actions initiated by the user in real-time within the technology environment.

6. The system of claim 5, wherein continuously updating further comprises:
monitoring the one or more actions executed by the one or more pre-configured bots deployed to execute the one or more actions initiated by the user;
receiving an indication that the one or more actions have been executed by the one or more pre-configured bots;
initiating a presentation of user interface for display on a user device, the user interface comprising one or more selectable options for the user to indicate whether the one or more actions initiated by the user have been executed successfully by the one or more pre-configured bots; and
receiving, via the user interface, a user selection of at least one of the one or more options indicating that the one or more pre-configured bots have successfully executed the one or more actions initiated by the user.

7. The system of claim 6, wherein the module is further configured to:
receive, via the user interface, the user selection of at least one of the one or more options indicating that the one or more pre-configured bots have not successfully executed the one or more actions initiated by the user;
receive, from the user, information associated with one or more actions initiated by the user that were not executed by the one or more pre-configured bots;
re-configure the one or more pre-configured bots to execute the one or more actions initiated by the user that were not executed by the one or more pre-configured bots; and
re-deploy the one or more pre-configured bots.

8. A computerized method for automated deployment of pre-configured bots for executing one or more actions initiated by a user within a technology environment based on a supervised classification of the user into a predetermined class, the method comprising:
receiving information associated with one or more actions initiated by a user within a technology environment;
generating one or more primary data points based on at least receiving information associated with one or more actions;
classifying the user into a class based on at least the one or more primary data points generated;
retrieving one or more pre-configured bots associated with the class, wherein the class is associated with one or more predetermined primary data points, wherein the one or more pre-configured bots are capable of executing the one or more actions initiated by the user; and
deploying the one or more pre-configured bots to execute the one or more actions initiated by the user.

9. The computerized method of claim 8, wherein classifying further comprises comparing the generated one or more primary data points with the one or more predetermined primary data points associated with the class.

10. The computerized method of claim 8, wherein the class is associated with one or more groups of one or more pre-configured bots.

11. The computerized method of claim 10, wherein the method further comprises retrieving the one or more pre-configured bots, wherein retrieving further comprises retrieving the one or more pre-configured bots associated with at least one of the one or more groups.

12. The computerized method of claim 8, wherein the method further comprises continuously updating the class associated with the user based on at least receiving information associated with one or more actions initiated by the user in real-time within the technology environment.

13. The computerized method of claim 12, wherein the method further comprises:
monitoring the one or more actions executed by the one or more pre-configured bots deployed to execute the one or more actions initiated by the user;
receiving an indication that the one or more actions have been executed by the one or more pre-configured bots;
initiating a presentation of user interface for display on a user device, the user interface comprising one or more selectable options for the user to indicate whether the one or more actions initiated by the user have been executed successfully by the one or more pre-configured bots; and
receiving, via the user interface, a user selection of at least one of the one or more options indicating that the one or more pre-configured bots have successfully executed the one or more actions initiated by the user.

14. The computerized method of claim 13, wherein the method further comprises:
receiving, via the user interface, the user selection of at least one of the one or more options indicating that the one or more pre-configured bots have not successfully executed the one or more actions initiated by the user;
receiving, from the user, information associated with one or more actions initiated by the user that were not executed by the one or more pre-configured bots;
re-configuring the one or more pre-configured bots to execute the one or more actions initiated by the user that were not executed by the one or more pre-configured bots; and
re-deploying the one or more pre-configured bots.

15. A computer program product for automated deployment of pre-configured bots for executing one or more actions initiated by a user within a technology environment based on a supervised classification of the user into a predetermined class, the computer program product comprising a non-transitory computer-readable medium comprising code causing a first apparatus to:
receive information associated with one or more actions initiated by a user within a technology environment;
generate one or more primary data points based on at least receiving information associated with one or more actions;
classify the user into a class based on at least the one or more primary data points generated;
retrieve one or more pre-configured bots associated with the class, wherein the class is associated with one or more predetermined primary data points, wherein the one or more pre-configured bots are capable of executing the one or more actions initiated by the user; and
deploy the one or more pre-configured bots to execute the one or more actions initiated by the user.

16. The computer program product of claim 15, wherein the first apparatus is further configured to classify the user into the class, wherein classifying further comprises comparing the generated one or more primary data points with the one or more predetermined primary data points associated with the class.

17. The computer program product of claim 15, wherein the each of the one or more classes are associated with one or more groups of one or more pre-configured bots.

18. The computer program product of claim 17, wherein the first apparatus is further configured to retrieve the one or more pre-configured bots, wherein retrieving further comprises retrieving the one or more pre-configured bots associated with at least one of the one or more groups.

19. The computer program product of claim 15, wherein the first apparatus is further configured to continuously update the class associated with the user based on at least receiving information associated with one or more actions initiated by the user in real-time within the technology environment.

20. The computer program product of claim 19, wherein continuously updating further comprises:
monitoring the one or more actions executed by the one or more pre-configured bots deployed to execute the one or more actions initiated by the user;
receiving an indication that the one or more actions have been executed by the one or more pre-configured bots;
initiating a presentation of user interface for display on a user device, the user interface comprising one or more selectable options for the user to indicate whether the one or more actions initiated by the user have been executed successfully by the one or more pre-configured bots; and
receiving, via the user interface, a user selection of at least one of the one or more options indicating that the one or more pre-configured bots have successfully executed the one or more actions initiated by the user.
